(19) United States
(12) Patent Application Publication
(10) Pub. No.: US 2014/0105213 A1
(43) Pub. Date: Apr. 17, 2014

(54) METHOD, APPARATUS AND SYSTEM FOR TRANSMITTING PACKETS IN VIRTUAL NETWORK

(71) Applicant: Huawei Technologies Co., Ltd., Shenzhen (CN)

(72) Inventors: Keshava A K, Bangalore (IN); Dhruv Dhody, Bangalore (IN)

(73) Assignee: Huawei Technologies Co., Ltd., Shenzhen (CN)

(21) Appl. No.: 14/010,109

(22) Filed: Aug. 26, 2013

(30) Foreign Application Priority Data
Oct. 17, 2012 (IN) IN4323/CHE/2012

(51) Int. Cl. H04L 12/741

(52) U.S. Cl. CPC H04L 45/74
USPC 370/392

(57) ABSTRACT

The embodiments of the present disclosure provide a method for transmitting packet in a Virtual Network. In the method, an access switch receives a Layer 3 packet carrying a VNID (Virtual Network IDentifier) from a VM in a remote Data Center. The access switch determines a DN (Designated Node) corresponding to the VNID and generates a Layer 2 frame according to the Layer 3 packet, where the Layer 2 frame includes the MAC (Media Access Control) address of the DN. The access switch to the DN transmits the Layer 2 frame according to the MAC address of the DN such that the DN determines a Layer 3 destination address according to the Layer 2 frame. This avoids packet flooding in Data Center when VM was migrated.

### CROSS-REFERENCE TO RELATED APPLICATIONS

This application claims priority to Indian Patent Application No. IN4323/CHE/2012, filed on Oct. 17, 2012, which is hereby incorporated by reference in its entirety.

### FIELD

This application relates to VN (Virtual Network), in particular, to a method, apparatus, and system for transmitting packets in virtual network for reducing ARP (Address Resolutin Protocol) flooding and MAC (Media Access Control) address table size in DC (Data Center).

### BACKGROUND

With introduction of VM (Virtual Machine), its migration to other physical sever in the DC will involve new challenges, such as scattered subnets may cross TORs (Top of Rack) and disjointed address may exist; but the migrated VMs will continue to maintain same IP address.

FIG. 1 is a schematic diagram of a topology of VMs in the prior art. Subnets will be scattered among many Access switches or Top of Rack (TOR) switches within the virtual network. In a very large and highly virtualized data center, there can be hundreds of thousands of VMs, sometimes even millions, due to business demand and highly advanced server virtualization technologies. Because of this ‘ARP table growth’, ‘exponential ARP flooding’ will take place in the Access Network. Managing the disjointed subnet across different TORs needs to be handled.

With introduction of hypervisor with VMs and Network virtualization in the Data Center, the size of MAC table will be very huge. This is the global problem that the Data Center needs to solve.

FIG. 2 is a schematic diagram of a topology of VM Migration in the prior art. For example, please refer to FIG. 2, under the VM migration scenario, ARP broadcast/multicast messages are no longer confined to smaller number of ports, and Access switch/Gateway router needs to flood all the ARP requests on all ports. Because of the VMs movement, VLAN span across multiple racks will force ARP broadcast. Therefore the data center has hundreds of thousands of VMs and thousands of Rack; When the VMs move across Racks, Access Switch MAC table will be very huge. In the flat Layer 2 network, with introduction of VM Migration, Access switch needs to know all the VMs's MAC addresses across all the TORs.

To solve this problem, the prior art provides two solutions, one is that each subnet was assigned to a TOR switch and VM Migration was disallowed, the other is enable Layer 3 capabilities on a TOR, but that causes the high cost and leads to the similar problem in the Layer 3 (L3).

However the applicant found that, there is a clear need for VM Migration in a flat Layer 2 (L2) network within the DC, but the current technology leads to exponential ARP flooding as well increase in MAC table size on the access switch. For example, when the VM is migrated from one TOR to other TOR, the other TOR do not know how to forward the packet of the VM, and Access switch will flood the packet over the whole Layer 2 Network, such that the Access switch may needs to maintain tens of thousands ARP Entries.

### SUMMARY

The present disclosure provides a method, apparatus and system for reducing ARP flooding and MAC address table size in DC.

According to a first aspect of the present disclosure, a method for transmitting packet in Virtual Network is provided, the method includes: receiving, by an access switch, a Layer 3 packet carrying a VNID (Virtual Network IDentifier) from a VM in a remote Data Center; determining, by the access switch, a DN (Designated Node) corresponding to the VNID; generating, by the access switch, a Layer 2 frame according to the Layer 3 packet, where, the Layer 2 frame includes the MAC (Media Access Control) address of the DN; and transmitting, by the access switch to the DN, the Layer 2 frame according to the MAC address of the DN, such that the UN determines Layer 3 destination address according to the Layer 2 frame.

According to a second aspect of the present disclosure, another method for transmitting packet in Virtual Network is provided, the method includes: receiving, by a TOR (Top of Rack) switch, a Layer 2 frame carrying a VNID; extracting, by the TOR switch, a Layer 3 destination address from the Layer 2 frame; determining, by the TOR switch, whether a VM (Virtual Machine) corresponding to the Layer 3 destination address is in the TOR switch or the VM has migrated; determining, another TOR switch to which the VM migrated, according to the Layer 3 destination address, when the VM has migrated, and transmitting the Layer 2 frame to the another TOR switch.

According to a third aspect of the present disclosure, a further method for transmitting packet in Virtual Network is provided, the method includes: receiving, by a TOR switch, an ARP transmitted by a VM which migrated to the TOR switch; checking, by the TOR switch, the VNID corresponding to the ARP; determining, by the TOR switch, whether the TOR switch is the DN corresponding to the VNID or not; generating, by the TOR switch, proxy ARP with the TOR MAC address, and broadcasting along with the VNID, when the TOR switch is not the DN corresponding to the VNID; updating, by the TOR switch, the Layer 2 table, when the TOR switch is the DN corresponding to the VNID.

According to a fourth aspect of the present disclosure, an access switch is provided, the access switch comprises: a receiving unit configured to receive a Layer 3 packet from a VM in a remote Data Center carrying a VNID (Virtual Network IDentifier); a determining unit configured to determine a DN (Designated Node) corresponding to the VNID, according to the VNID; a generating unit configured to generate a Layer 2 frame according to the Layer 3 packet, where, the Layer 2 frame includes the MAC (Media Access Control) address of the DN; and a transmitting unit configured to transmit the Layer 2 frame to the DN according to the MAC address of the DN, such that the DN determines a Layer 3 destination address according to the Layer 2 frame.

According to a fifth aspect of the present disclosure, a TOR switch is provided, the TOR switch comprises: a receiving unit configured to receive a Layer 2 frame along with a VNID; an extracting unit configured to extracting a Layer 3 destination address from the Layer 2 frame; a determining unit configured to determine whether a VM corresponding to the Layer 3 destination is in the TOR switch or has migrated, a first performing unit configured to determine another TOR switch to which the VM migrated, according to the Layer 3 destination address, and transmit the Layer 2 frame to the another TOR switch where the VM migrated, when the VM has migrated.

According to a sixth aspect of the present disclosure, another TOR switch is provided, the TOR switch comprises: a receiving unit configured to receive an ARP transmitted by a VM which migrated to the TOR switch; a checking unit configured to determine the VNID corresponding to the ARP; a determining unit configured to determine whether the TOR switch is the DN corresponding to the VNID or not; a performing unit configured to generate proxy ARP with the TOR MAC address and broadcast carrying the VNID, if the TOR switch is not the DN corresponding to the VNID, and an updating unit configured to update the Layer 2 table, if the TOR switch is the DN corresponding to the VNID.

According to a seventh aspect of the present disclosure, a communication system is provided, the system comprises: an access switch configured to receive a Layer 3 packet from a remote Data Center carrying a VNID, determine a DN corresponding to the VNID, generate a Layer 2 frame carrying the VNID according to the Layer 3 packet, and transmit the Layer 2 frame to the DN; and a plurality of TOR switches, each configured to receive the Layer 2 frame carrying the VNID, extract a Layer 3 destination address according to the Layer 2 frame, determine another TOR switch or a migrated VM, and transmit the Layer 2 frame to the another TOR switch or the migrated VM.

The advantages of the present disclosure are that, first, it can avoid the packet flooding in data center when a VM is migrated; second, it can avoid the ARP broadcast when a VM is migrated to different TORs; third, it can avoid the growing ARP table size in access switch; fourth, it can avoid the growing ARP table size in TOR.

### BRIEF DESCRIPTION OF THE DRAWINGS

The drawings are included to provide further understanding of the present disclosure, which constitute a part of the specification and illustrate the preferred embodiments of the present disclosure, and are used for setting forth the principles of the present disclosure together with the description. The same element is represented with the same reference number throughout the drawings.

FIG. 1 is a schematic diagram of a topology of VMs in the prior art.

FIG. 2 is a schematic diagram of a topology of VM Migration in the prior art.

FIG. 3 is a schematic diagram of the topology of a DC network in the present disclosure.

FIG. 4 is a flowchart of a method according to one embodiment of the present disclosure.

FIG. 5 is a flowchart of a method according to another embodiment of the present disclosure.

FIG. 6 is a flowchart of a method according to another embodiment of the present disclosure.

FIG. 7 is a schematic diagram of the topology of DC network in one embodiment.

FIG. 8 is a sequence diagram showing the packet-Exchange between switches according to the embodiment of FIG. 7.

FIG. 9 is a sequence diagram showing the migrated VM in ARP learning in DN table.

FIG. 10 is a schematic diagram of an access switch according to one embodiment of the present disclosure.

FIG. 11 is a schematic diagram of a TOR switch according to one embodiment of the present disclosure.

FIG. 12 is a schematic diagram of another TOR switch according to one embodiment of the present disclosure.

FIG. 13 is a schematic diagram of a system including the access switch in FIG. 10 and the switches in FIGS. 11 and 12.

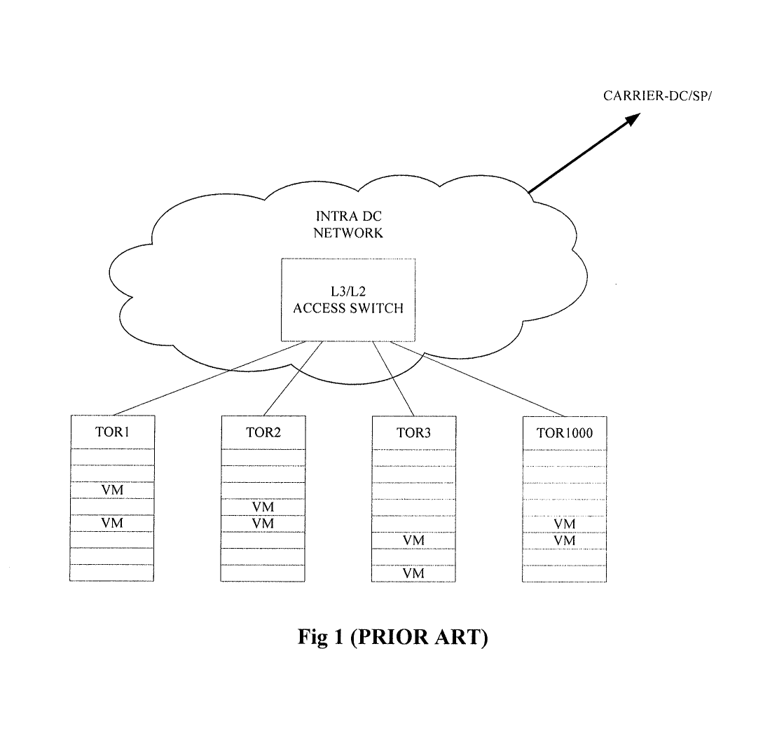

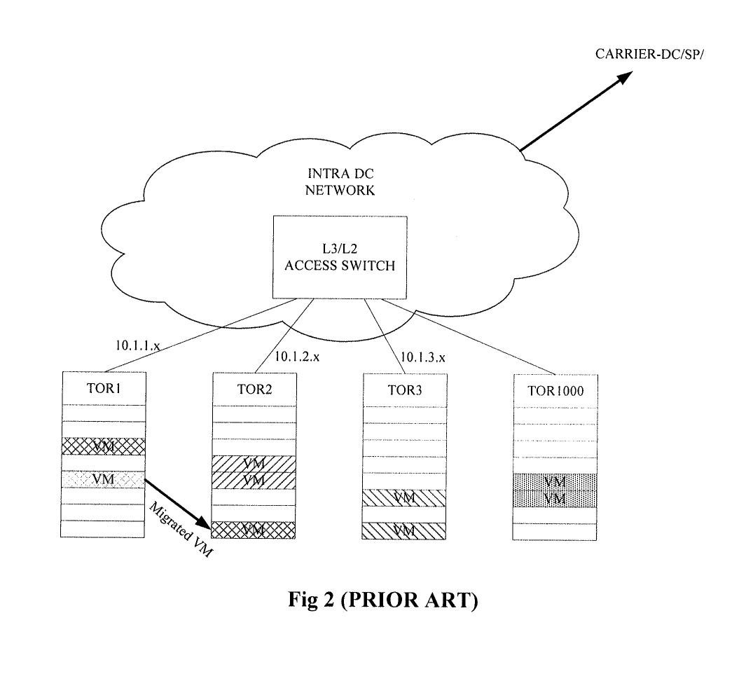

### DESCRIPTION OF EMBODIMENTS

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof′.

In the present application, embodiments of the disclosure are described primarily in the context of access switch and TOR switches in Virtual Network. However, it shall be appreciated that the disclosure is not limited to the context of access switch and TOR switches, and may relate to any type of appropriate electronic apparatus having the function of switches.

The preferred embodiments of the present disclosure are described as follows in reference to the drawings.

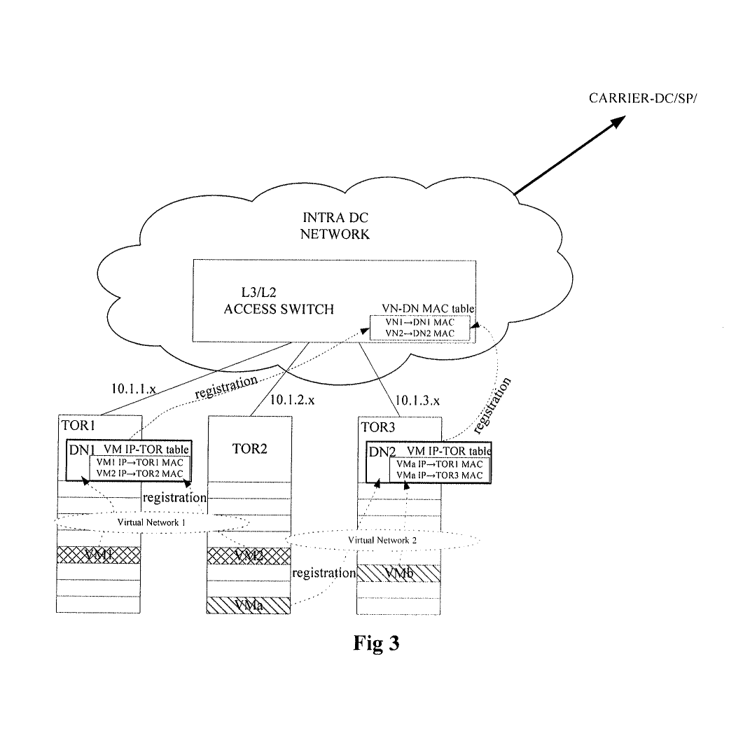

FIG. 3 is a schematic diagram of the topology of a DC network in the present disclosure. As shown in FIG. 3, there are one access switch (Layer 3/Layer 2 switch) and three TOR switches (TOR1, TOR2 and TOR3). In this topology, VM1 and VM2 belong to Virtual Network 1, VM1 is in TOR1 switch, VM2 is in TOR2 switch, and TOR1 is identified as Designated Node (DN1) of the Virtual Network 1. In this topology, VMa and VMb belong to Virtual Network 2, VMa is in TOR2 switch, VMb is in TOR3 switch, and TOR3 is identified as Designated Node (DN2) of the Virtual Network 2.

In an embodiment of the present disclosure, the access switch preserves VN-DN MAC table, the VN-DN MAC table indicates the mapping between VN and DN. For example, when DN is designated to respective ‘Virtual Network Identifier’, the access switch will maintain the mapping table between ‘Virtual Network Identifier’ and ‘Designated Node MAC’. As shown in FIG. 3, in the VN-DN MAC table, VN1 corresponds to DN1 MAC address, as mentioned above, TOR1 is identified as DN1, which means TOR1 switch is the DN of VN1, similarly, VN2 corresponds to DN2 MAC address, and TOR3 switch is the DN of VN2.

In an embodiment of the present disclosure, each DN preserves Layer 2 table, the Layer 2 table indicated the mapping between VM IP address and TOR MAC address, or the Layer 2 table indicates a Mapping between VM IP address and VM MAC address, or the Layer 2 table indicates a mapping between VM IP address and TOR MAC address and a Mapping between VM IP address and VM MAC address. For example, for Migrated VM, the Layer 2 table will maintain a mapping between VM IP address and TOR MAC address learned via proxy ARP learning; for non-migrated VM, the Layer 2 table will maintain a mapping between VM IP address and VM MAC address. As shown in FIG. 3, because VM1 is in TOR1, VM2 is in TOR2, VMa was in TOR1 and moved to TOR2, VMb is in TOR2, so in the Layer 2 table that DN1 preserves, VM1 IP address corresponds to TOR1 MAC address, VM2 IP address corresponds to TOR2 MAC address, and in Layer 2 table that DN2 preserves, VMa IP address corresponds to TOR1 MAC address, VMb IP address corresponds to TOR3 MAC address.

Refer to FIG. 3, the TOR1, TOR2 and TOR3 are registered to access switch, the VM1 and VM2 are registered to Virtual Network 1, VMa and VMb are registered to Virtual Network 2. The registration process can be achieved by existing method, which shall not be described any further.

The method, apparatus and system according to the embodiments of the present disclosure will be described in detail in the following in connection with the figures.

### Embodiment 1

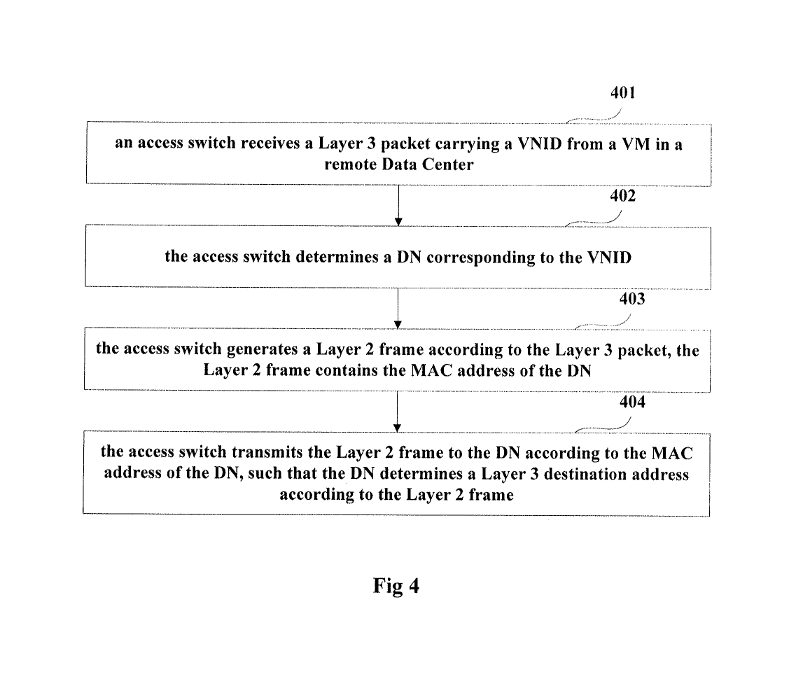

The embodiment of the present disclosure provides a method for transmitting a packet in Virtual Network. FIG. 4 is a flowchart of the method according to an embodiment of the present disclosure. As shown in FIG. 4, the method comprises:

step 401: an access switch receives a Layer 3 packet carrying a VNID (Virtual Network IDentifier) from a remote Data Center;

The Layer 3 packet is sent from one VM to another VM in the Data Center. In the embodiment, the VM which sends the Layer 3 packet is called as VMs (VM source), the VM which receives the Layer 3 packet is called as VMd (VM destination). The VMs sends the ARP request to find the destination MAC address. Local TOR will generate the ARP reply, where, if the TOR is unknown or non-local, the ARP reply is with access switch MAC;

The Layer 3 packet is used to indicate a packet in Layer 3, the packet can carry data, control information and so on, it is defined in TCP/IP (Transmission Control Protocol/Internet Protocol), and the content is combined here and do not described any further.

step 402: the access switch determines a DN (Designated Node) corresponding to the VNID;

step 403: the access switch generates a Layer 2 frame according to the Layer 3 packet, the Layer 2 frame comprises the MAC (Media Access Control) address of the DN; and

step 404: the access switch transmits the Layer 2 frame to the DN according to the MAC address of the DN, such that the DN determines a Layer 3 destination address according to the Layer 2 frame.

Where, once the Layer 2 frame reaches the access switch originated from the VMs to the VMd, it will follow the same flow as if it has come from outside DC as explained earlier.

In an implementation of step 402, the access switch looks up a VN-DN MAC table according to the VNID, and determines the DN corresponding to the VNID. The VN-DN MAC Table indicates a Mapping between DN MAC address and VNID as described above.

In this embodiment, when a Virtual Network is spanned across Multiple TORs, one of the TOR switch will be identified as ‘Designated Node’ (DN) by configuration. Access switch will only maintain DN's MAC address with regard to corresponding Virtualization entity (Virtual Network). That is to say, each Virtual Network corresponds to a DN, access switch maintains a VN-DN MAC table which indicates the relationship of each VN and its DN, and finds out the destination TOR (DN) by looking up the table.

With the embodiment of the method, the ARP flooding can be reduced or avoided in the access network, and the Layer 2 table (VN-DN MAC table) can be controlled in access switch.

### Embodiment 2

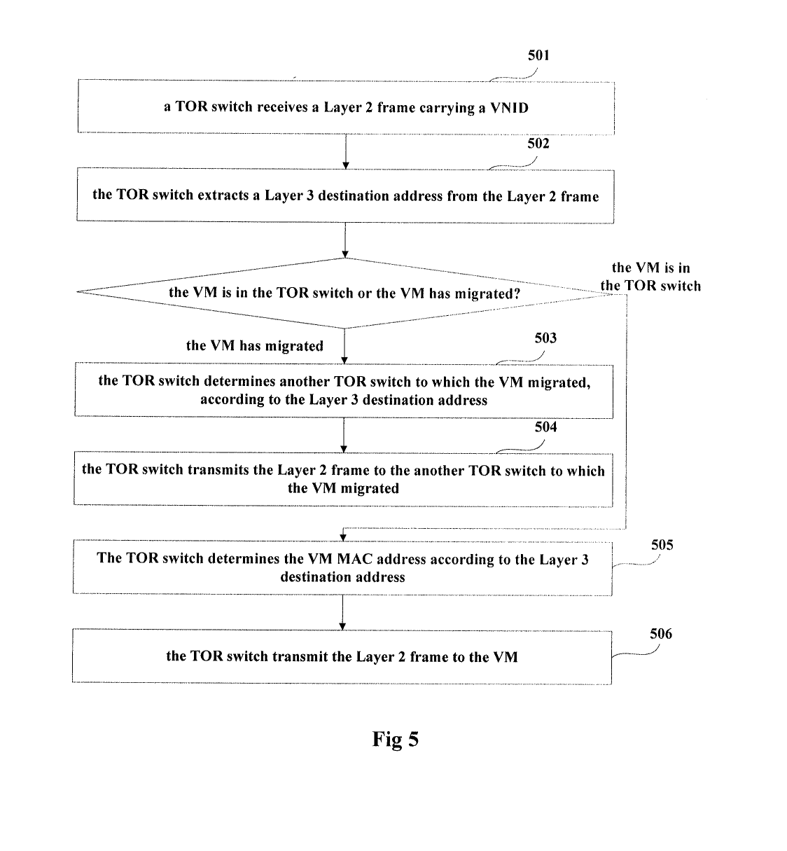

The embodiment of the present disclosure provides a method for transmitting packets in Virtual Network. FIG. 5 is a flowchart of the method according to an embodiment of the present disclosure. As shown in FIG. 5, the method comprises:

step 501: a TOR switch receives a Layer 2 frame carrying a VNID;

where, the Layer 2 frame also carries a MAC address so as to reach the TOR switch.

Where, the Layer 2 frame corresponds to the Layer 3 packet described in embodiment 1, and the Layer 2 frame is sent from the VMs to the VMd.

step 502: the TOR switch extracts a Layer 3 destination address from the Layer 2 frame;

where, the TOR switch can extract the Layer 3 destination address by peeking into the Layer 2 frame. It can be achieved by existing method and shall not be described any further.

step 503: the TOR switch decides whether the VMd is in the TOR switch or the VMd has migrated.

In one embodiment, the VMd is in the TOR switch, in another embodiment, the VMd has migrated. If the VMd has migrated, then step 504-505 are carried out, if the VMd is in the TOR, then step 506-507 are carried out;

step 504: the TOR switch determines another TOR switch to which the VMd migrated, according to the VNID and the Layer 3 destination address;

where, the migrated VM (VMd) is the destination of the Layer 2 frame (Layer 3 packet), because the VMd is migrated, its TOR switch should be redetermined.

step 505: the TOR switch transmits the Layer 2 frame to the another TOR switch to which the VMd migrated.

The TOR switch of this embodiment will receive the Layer 2 frame transmitted by the access switch described in embodiment 1, and determine the destination VM of the Layer 2 frame.

In an implement way of step 504, the TOR switch looks up a Layer 2 table according to the VNID and the Layer 3 destination address, and determines the another TOR switch to which the VM migrated. The Layer 2 table indicates a mapping between VM IP address and TOR MAC address for Migrated VM, or the Layer 2 table indicate a mapping between VM IP address and VM MAC address for non-migrated VM as described above, or the Layer 2 table indicated a mapping between VM IP address and TOR MAC address for Migrated VM and a mapping between VM IP address and VM MAC address for non-migrated VM as described above. With the Layer 2 table, the TOR switch can find out the destination of the Layer 2 frame.

In this embodiment, the TOR switch is the DN of the Virtual Network, after receiving the Layer 2 frame, the DN (the TOR switch) will peek into Layer 3 destination address according to the Layer 2 frame, and lookup the Layer 2 table described above with VNID and the Layer 3 destination address as key, and get the MAC address of the another TOR (to which the VMd was migrated), and generate Layer 2 frame carrying the TOR MAC address, and transmit the Layer 2 frame to the another TOR switch.

In another embodiment, the VM is in the TOR switch, then, the method further comprises:

step 506: the TOR switch determines the VM MAC address according to the VNID and the Layer 3 destination address;

Where, the VM is the VMd. In the embodiment, since the VMd is in the TOR switch, so the destination TOR switch has decided, and then the VMd MAC address should be determined for transmitting the Layer 2 frame to its destination.

step 507: the TOR switch transmits the Layer 2 frame to the VM;

where, in step 506, the MAC address of the VMd has been determined, in step 507, the Layer 2 frame can be transmit to the VMd.

In an implementation of step 505, the TOR switch looks up the Layer 2 table according to the VNID and the Layer 3 destination address, and determines the migrated VM, where, the Layer 2 table indicates a Mapping between VM IP address and TOR MAC address for Migrated VM, or the Layer 2 table indicates a Mapping between VM IP address and VM MAC address for non-migrated VM as described above, or the Layer 2 table indicates a Mapping between VM IP address and TOR MAC address for Migrated VM and a Mapping between VM IP address and VM MAC address for non-migrated VM as described above.

In this embodiment, the TOR switch is not the DN of the Virtual Network, but it is the TOR switch where the VMd migrated, after receiving the Layer 2 frame, the TOR switch will peek into Layer 3 destination address according to the Layer 2 frame, and lookup the Layer 2 table described above with VNID and the Layer 3 destination address as key, and get the MAC address of the VMd, and forward the Layer 2 frame with the MAC address of the VMd as destination MAC address which reach physical hosts/server based on local edge virtual bridge technology.

With the embodiment of the method, the ARP flooding can be reduced or avoided in access network, and the Layer 2 table can be controlled in access switch.

### Embodiment 3

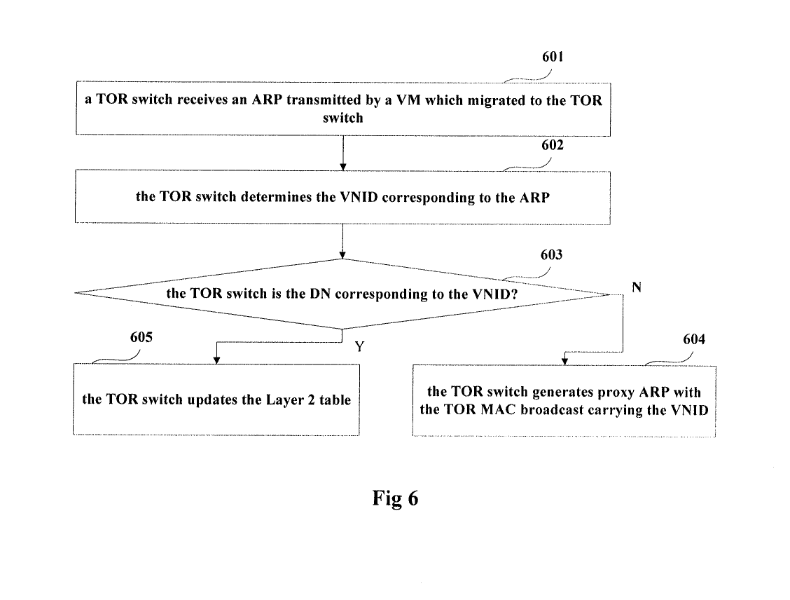

The embodiment of the present disclosure provides a method for transmitting packets in Virtual Network. FIG. 6 is a flowchart of the method according to an embodiment of the present disclosure. As shown in FIG. 6, the method comprises:

step 601: a TOR switch receives an ARP broadcast transmitted by a VM which migrated to the TOR switch;

where, whenever a VM migrated to a new physical server, like the TOR switch, it will generate an ARP broadcast with VM MAC address, and broadcast the ARP from its server to the physical server (the TOR switch).

step 602: the TOR switch determines a VNID corresponding to the ARP request;

where, the TOR switch will check the VNID corresponds to the ARP broadcast by available mechanism, such as interface, ARP which depends on VMware implementation.

step 603: the TOR switch determines whether the TOR switch is the DN corresponding to the VNID;

step 604: if the TOR switch is not the DN corresponding to the VNID, the TOR switch generates a proxy ARP broadcast with the TOR MAC address and broadcasts the proxy ARP broadcast along with the VNID;

step 605: if the TOR switch is the DN corresponding to the VNID, the TOR switch updates the Layer 2 table.

With the embodiment of the method, the ARP flooding can be reduced or avoided in access network, and the Layer 2 table can be controlled in access switch.

For further understanding of the method of embodiments 1-3, the method of the present disclosure shall be described in detail with respect to a process of transmission of a Layer 3 packet in a virtual network in conjunction with the accompanying drawings.

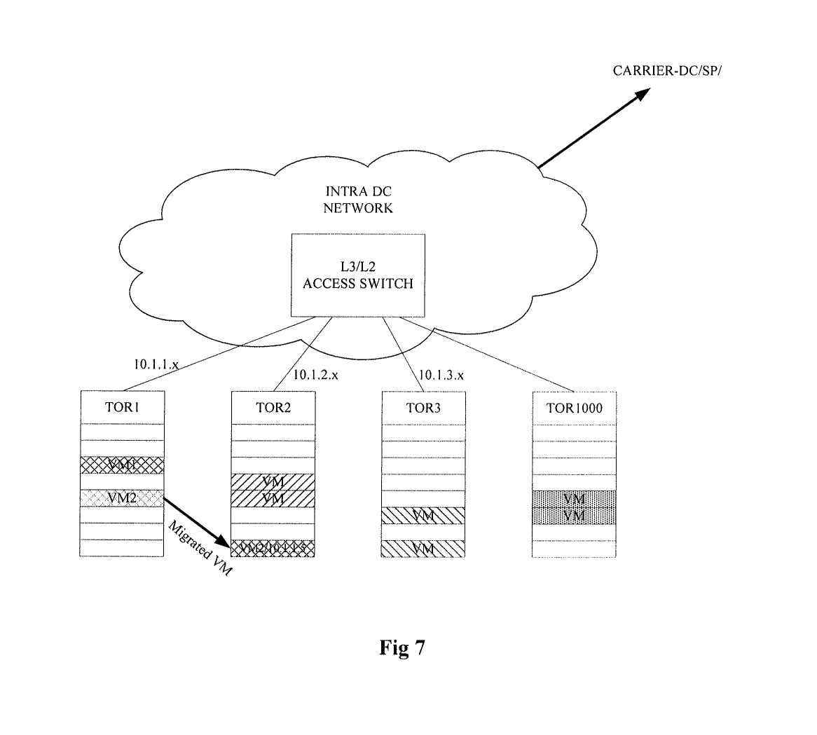

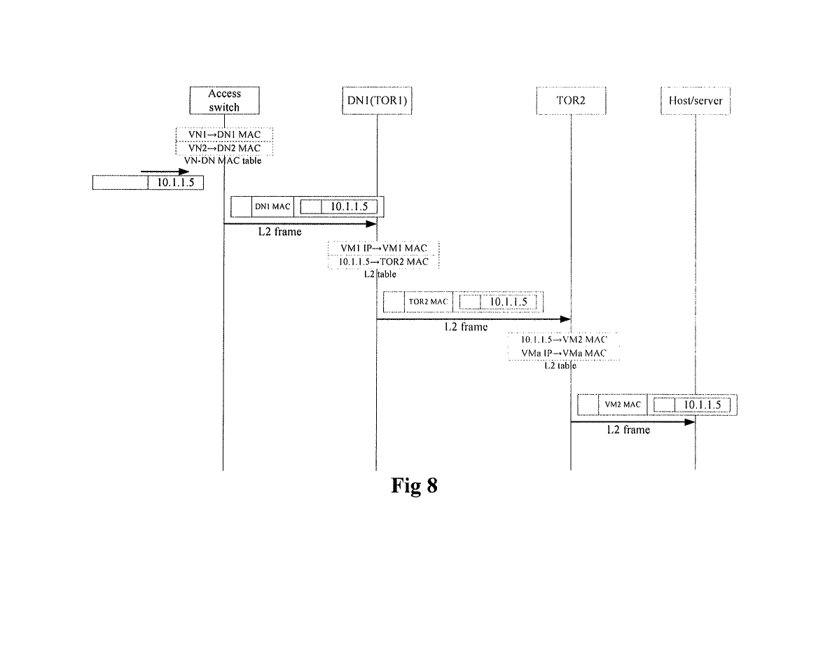

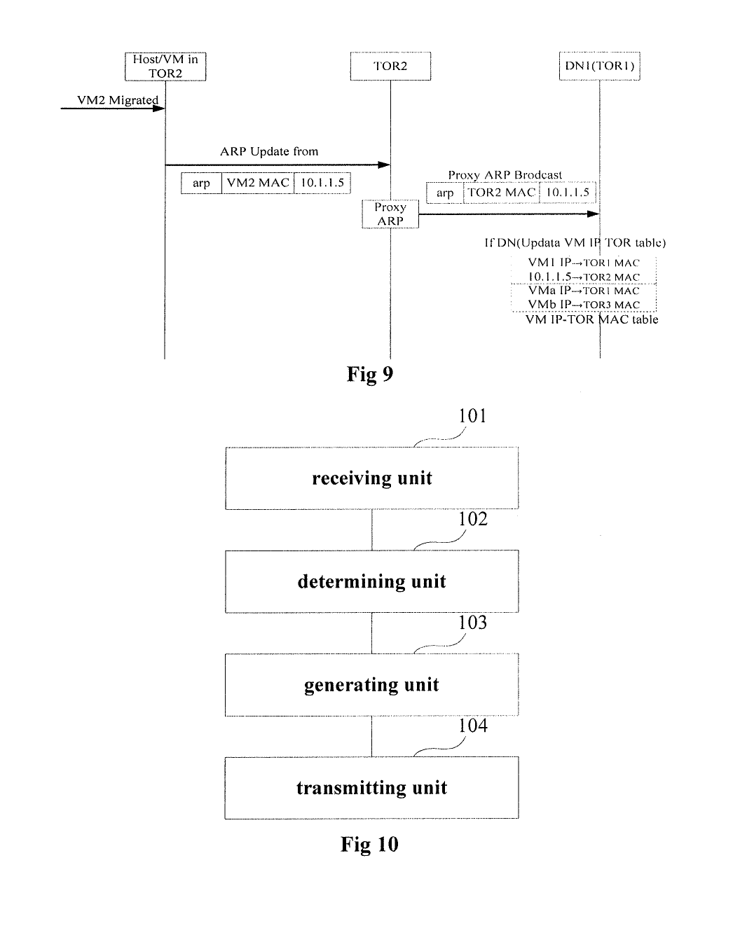

FIG. 7 is a schematic diagram of the topology of a DC network of this embodiment. FIG. 8 is a flowchart of a Layer 3 packet in transmission in an access switch and TOR1 and TOR2. FIG. 9 is a flowchart of migrated VM ARP learning in DN table.

Please refer to FIG. 7, in this embodiment, VM1 is in TOR1, VM2 was in TOR1 and migrated to TOR2, the IP address of TOR1 is 10.1.1.x, the IP address of TOR2 is 10.1.2.x, the IP address of TOR3 is 10.1.3.x. The IP address of VM2 is 10.1.1.5.

Please refer to FIG. 8, a Layer 3 packet received at access switch from remote DC to a migrated VM2 with IP address 10.1.1.5, the VM2 (which was earlier in TOR1) is in TOR2.

### For Access Switch as Described in Embodiment 1.

The access switch maintains a VN-DN MAC table, as shown in FIG. 8, in the VN-DN MAC table, VN1 corresponds to DN1 MAC address, VN2 corresponds to DN2 MAC address. The access switch receives a Layer 3 packet carrying a VNID (Virtual Network Identifier) form the remote Data Center, by looking up the VN-DN MAC table, the access switch determines the DN corresponding to the VNID. Therefore, the access switch can creates a Layer 2 frame according to the Layer 3 packet, and the Layer 2 frame carries the MAC address of the DN, so that it can be forwarded to the DN. In the Layer 2 frame, there is a bit set, so that the DN will determine the Layer 3 destination address.

### For DN1 (TOR1 Switch) as Described in Embodiment 2.

The DN1 maintains a Layer 2 table, as shown in FIG. 8, in the Layer 2 table, since VM1 is non-migrated, VM1 IP address corresponds to VM1 MAC address, and since VM2 is migrated, VM2 IP address (10.1.1.5) corresponds to TOR2 MAC address. After receiving the Layer 2 frame, the DN1 will extract the Layer 3 destination address from the Layer 2 frame since there is a special bit set in the Layer 2 frame. By looking up the Layer 2 table preserved in the DN1 with the Layer 3 destination address (10.1.1.5) as key, the DN1 can get a MAC address of TOR2 to which VM2 was migrated. And then, the DN1 generates Layer 2 frame carrying the MAC address of the TOR2 and forwards the Layer 2 frame to the TOR2.

### For TOR2 Switch as Described in Embodiment 2.

Like TOR1 switch in embodiment 2, the TOR2 maintains a Layer 2 table, as shown in FIG. 8, in the Layer 2 table, VM2 IP (10.1.1.5) corresponds to VM2 MAC, VMa IP corresponds to VMa MAC. After receiving the Layer 2 frame, the TOR2 switch will peek into Layer 3 destination address (which is 10.1.1.5) since there is a special bit set in the Layer 2 frame. By looking up the Layer 2 table preserved in the TOR2 with the Layer 3 destination address (10.1.1.5) as key, the TOR2 can get a MAC address of VM2 to which the VM2 was migrated. And then, the TOR2 generates Layer 2 frame carrying the MAC address of the VM2 and forwards the Layer 2 frame carrying VM2 MAC address as destination MAC address which will reach physical hosts/server based on local edge virtual bridge technology.

As described in embodiment 3, whenever the VM2 migrated (on top of TOR2), it will broadcast its ARP broadcast from it's server (host/VM in TOR2) to TOR2, in this case, the TOR2 will check corresponding VNID by available mechanism, such as interface/ARP which depends on implementation. If TOR is not the DN corresponds to the VNID, such as TOR2, the TOR will generate proxy ARP broadcast (with TOR2 MAC address and VM IP address) carrying the VNID, as shown in FIG. 9. If the TOR is the DN corresponds to the VNID, such as TOR1, the TOR will update its Layer 2 table, as shown in FIG. 9.

With regard to the embodiments 1-3 of method according to the present disclosure, the packet flooding in data center when the VM is migrated, the ARP broadcast when VM is migrated to different TORs, the growing ARP table size in access switch, and the growing ARP table size in TOR switch have been avoided.

### Embodiment 4

This embodiment of the present disclosure further provides an access switch. This embodiment corresponds to the method of the above embodiment 1 and the same content will not be described further.

FIG. 10 is a schematic diagram of the access switch according to an embodiment of the present disclosure. Other parts of the access switch can refer to the existing technology and not be described in the present application.

As shown in FIG. 10, the access switch includes a receiving unit 101, a determining unit 102, a generating unit 103, and a transmitting unit 104.

The receiving unit 101 is used to receive a Layer 3 packet from a remote Data Center carrying a VNID, the determining unit 102 is used to determine a DN corresponding to the VNID according to the VNID, the generating unit 103 is used to generate a Layer 2 frame according to the Layer 3 packet, where, the Layer 2 frame includes the MAC (Media Access Control) address of the DN, and the transmitting unit 104 is used to transmit the Layer 2 frame to the DN according to the MAC address of the DN, such that the DN determines a Layer 3 destination address according to the Layer 2 frame.

In this embodiment, the determining unit 102 is used to look up a VN-DN MAC table according to the VNID, and determine the DN corresponding to the VNID. In which, the VN-DN MAC Table indicates a Mapping between Designated Node MAC address and Virtual Network IDentifier.

With the embodiment of the access switch, the ARP flooding can be reduced or avoided in access network, and the Layer 2 table (VN-DN MAC table) can be controlled in access switch.

### Embodiment 5

This embodiment of the present disclosure further provides a TOR switch. This embodiment corresponds to the method of the above embodiment 2 and the same content will not be described further.

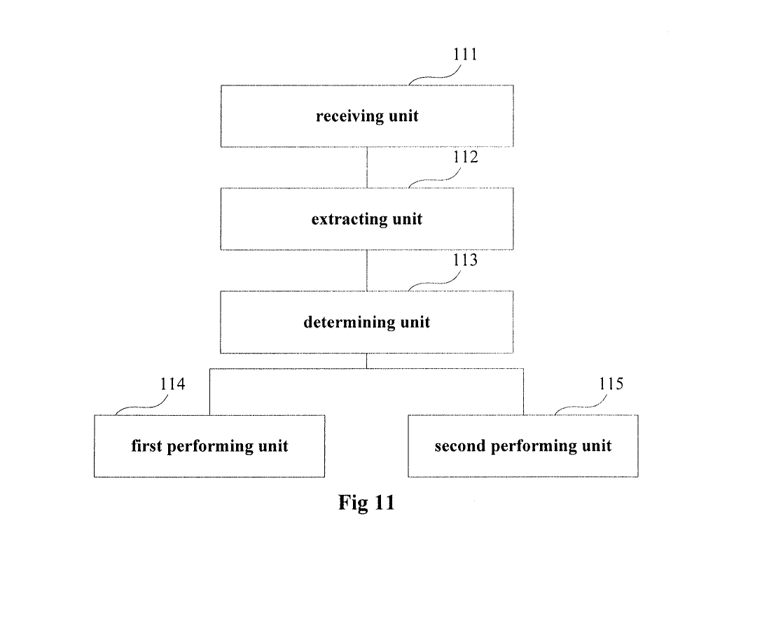

FIG. 11 is a schematic diagram of the TOR switch according to an embodiment of the present disclosure. Other parts of the TOR switch can refer to the existing technology and not be described in the present application.

As shown in FIG. 11, the TOR switch includes a receiving unit 11, an extracting unit 112, a determining unit 113, a first performing unit 114, and a second performing unit 115.

The receiving unit 111 is used to receive a Layer 2 frame along with a VNID. The extracting unit 112 is used to extract a Layer 3 destination address from the Layer 2 frame. The determining unit 113 is used to determine whether the VM is in the TOR switch or the VM has migrated. The first performing unit 114 is used to determine another TOR switch to which a VM was migrated according to the Layer 3 destination address, and transmit the Layer 2 frame to the another TOR switch to which the VM was migrated, when the VM has migrated. The second performing unit 115 is used to determine the VM MAC address according to the Layer 3 destination address, and transmit the Layer 2 frame to the VM, when the VM is in the TOR switch.

In this embodiment, the first performing unit 114 is used to look up a Layer 2 table according to the Layer 3 destination address, and determine the another TOR switch to which the VM was migrated. where, the Layer 2 table indicates a Mapping between VM IP address and TOR MAC address for Migrated VM, or the Layer 2 table indicates a Mapping between VM IP address and VM MAC address for non-migrated VM, or the Layer 2 table indicates a Mapping between VM IP address and TOR MAC address for Migrated VM and a Mapping between VM IP address and VM MAC address for non-migrated VM.

In this embodiment, the second performing unit 115 is used to look up a Layer 2 table according to the Layer 3 destination address, and determine the migrated VM. where, the Layer 2 table indicates a Mapping between VM IP address and TOR MAC address for Migrated VM, or the Layer 2 table indicates a Mapping between VM IP address and VM MAC address for non-migrated VM, or the Layer 2 table indicates a Mapping between VM IP address and TOR MAC address for Migrated VM and a Mapping between VM IP address and VM MAC address for non-migrated VM.

With the embodiment of the TOR switch, the ARP flooding can be reduced or avoided in access network, and the Layer 2 table can be controlled in access switch.

### Embodiment 6

This embodiment of the present disclosure further provides a TOR switch. This embodiment corresponds to the method of the above embodiment 3 and the same content will not be described further.

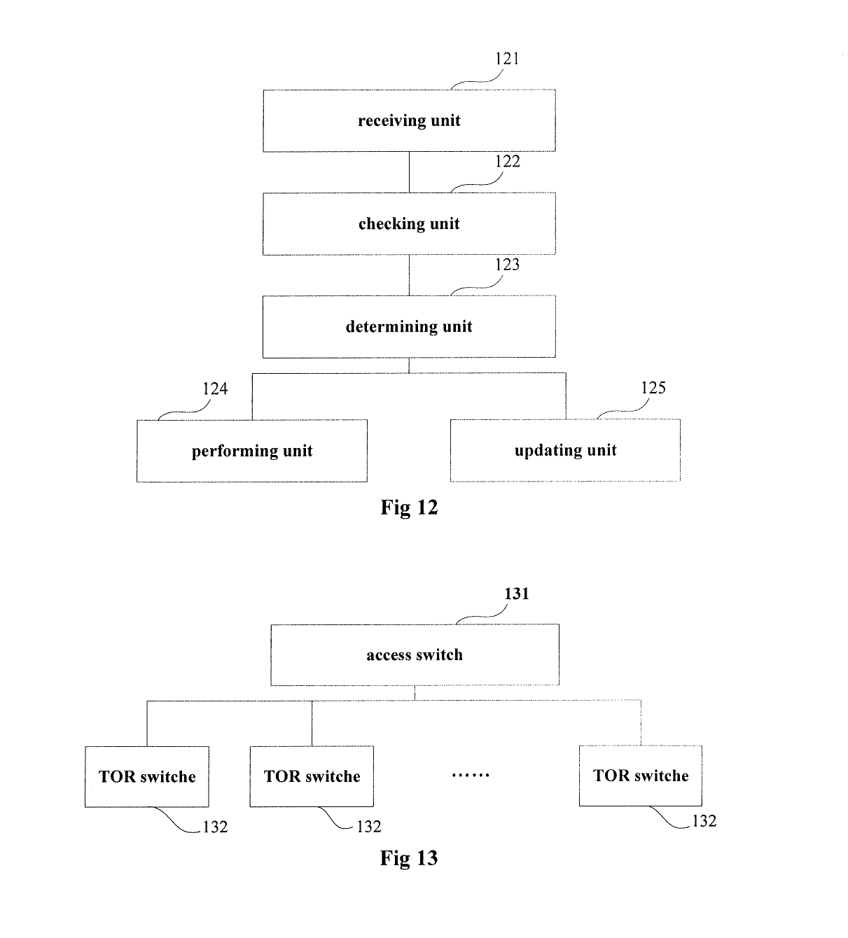

FIG. 12 is a schematic diagram of the TOR switch according to an embodiment of the present disclosure. Other parts of the TOR switch can refer to the existing technology and not be described in the present application.

As shown in FIG. 12, the TOR switch includes a receiving unit 121, a checking unit 122, a determining unit 123, a performing unit 124, and an updating unit 125.

The receiving unit 121 is used to receive an ARP broadcast transmitted by a VM which migrated to the TOR switch, the checking unit 122 is used to determine a VNID corresponding to the ARP, the determining unit 123 is used to determine whether the TOR switch is the DN corresponding to the VNID, the performing unit 124 is used to generates a proxy ARP broadcast with the TOR MAC address and broadcasts the proxy ARP broadcast carrying the VNID, when the TOR switch is not the DN corresponding to the VNID, the updating unit 125 is used to update the Layer 2 table, when the TOR switch is the DN corresponding to the VNID.

With the embodiment of the TOR switch, the ARP flooding can be reduced or avoided in access network, and the Layer 2 table can be controlled in access switch.

### Embodiment 7

This embodiment of the present disclosure further provides a communication system. FIG. 13 is a schematic diagram of the system according to an embodiment of the present disclosure.

As shown in FIG. 13, the system includes an access switch 131 and a plurality of TOR switches 132.

the access switch 131 is used to receive a Layer 3 packet from a remote Data Center carrying a VNID, determine a DN corresponding to the VNID, generate a Layer 2 frame along carrying the VNID according to the Layer 3 packet, and transmit the Layer 2 frame to the DN; and each TOR switch 132 is used to receive the Layer 2 frame carrying the VNID, extract a Layer 3 destination address according to the Layer 2 frame, determine another TOR switch or a migrated VM, and transmit the Layer 2 frame to the another TOR switch or the migrated VM.

In this embodiment, the access switch 131 is used to look up a VN-DN MAC table according to the VNID, and determine the DN corresponding to the VNID, in which, the VN-DN MAC Table indicates a Mapping between Designated Node MAC address and Virtual Network IDentifier.

In this embodiment, one of the TOR switches is used to look up a Layer 2 table according to the VNID and the Layer 3 destination address, and determine the another TOR switch to which the VM migrated, in which, the Layer 2 table indicates a Mapping between VM_IP address and TOR_MAC address for Migrated VM, or the Layer 2 table indicates a Mapping between VM_IP address and VM_MAC address for non-migrated VM, or the Layer 2 table indicates a Mapping between VM_IP address and TOR_MAC address for Migrated VM and a Mapping between VM_IP address and VM_MAC address for non-migrated VM.

In this embodiment, each of other TOR switches except one is used to look up a Layer 2 table according to the VNID and the Layer 3 destination address, and determine the migrated VM, in which, the Layer 2 table indicates a Mapping between VM_IP address and TOR_MAC address for Migrated VM, or the Layer 2 table indicates a Mapping between VM_IP address and VM_MAC address for non-migrated VM, or the Layer 2 table indicates a Mapping between VM_IP address and TOR_MAC address for Migrated VM and a Mapping between VM_IP address and VM_MAC address for non-migrated VM.

In this embodiment, each of the TOR switches is further used to check VNID to which the VM corresponds, generate a proxy ARP broadcast carrying the VNID, if the TOR switch is not the DN corresponding to the VNID, update the Layer 2 table, if the TOR switch is the DN corresponding to the VNID.

In the embodiment of the system of the present disclosure, the access switch 131 can be implemented with access switch in embodiment 4, and the content is combined here, and do not described further.

In the embodiment of the system of the present disclosure, the TOR switch 132 can be implemented with TOR switch in embodiment 5, or embodiment 5 and 6, and the content is combined here, and do not described further.

With regard to the system of the present disclosure, avoided the packet flooding in data center when the VM is migrated, avoided the ARP broadcast when VM is migrated to different TORs, avoided the growing ARP table size in access switch, and avoided the growing ARP table size in TOR switch.

The embodiments of the present disclosure further provide a computer-readable program, wherein when the program is executed in an access switch, the program enables the computer to carry out the method for transmitting packet in virtual network as described in embodiment 1.

The embodiments of the present disclosure further provide a storage medium in which a computer-readable program is stored, wherein the computer-readable program enables the computer to carry out the method for transmitting packet in virtual network as described in embodiment 1.

The embodiments of the present disclosure further provide a computer-readable program, wherein when the program is executed in a TOR switch, the program enables the computer to carry out the method for transmitting packet in virtual network as described in embodiment 2 or embodiment 3.

The embodiments of the present disclosure further provide a storage medium in which a computer-readable program is stored, wherein the computer-readable program enables the computer to carry out the method for transmitting packet in virtual network as described in embodiment 2 or embodiment 3.

It should be understood that each of the parts of the present disclosure may be implemented by hardware, software, firmware, or a combination thereof. In the above embodiments, multiple steps or methods may be realized by software or firmware that is stored in the memory and executed by an appropriate instruction executing system. For example, if it is realized by hardware, it may be realized by any one of the following technologies known in the art or a combination thereof as in another embodiment: a discrete logic circuit having a logic gate circuit for realizing logic functions of data signals, application-specific integrated circuit having an appropriate combined logic gate circuit, a programmable gate array (PGA), and a field programmable gate array (FPGA), etc.

The description or blocks in the flowcharts or of any process or method in other manners may be understood as being indicative of comprising one or more modules, segments or parts for realizing the codes of executable instructions of the steps in specific logic functions or processes, and that the scope of the preferred embodiments of the present disclosure comprise other implementations, wherein the functions may be executed in manners different from those shown or discussed, including executing the functions according to the related functions in a substantially simultaneous manner or in a reverse order, which should be understood by those skilled in the art to which the present disclosure pertains.

The logic and/or steps shown in the flowcharts or described in other manners here may be, for example, understood as a sequencing list of executable instructions for realizing logic functions, which may be implemented in any computer readable medium, for use by an instruction executing system, device or apparatus (such as a system including a computer, a system including a processor, or other systems capable of extracting instructions from an instruction executing system, device or apparatus and executing the instructions), or for use in combination with the instruction executing system, device or apparatus.

The above literal description and drawings show various features of the present disclosure. It should be understood that those skilled in the art may prepare appropriate computer codes to carry out each of the steps and processes as described above and shown in the drawings. It should be also understood that all the terminals, computers, servers, and networks may be any type, and the computer codes may be prepared according to the disclosure to carry out the present disclosure by using the apparatus.

Particular embodiments of the present disclosure have been disclosed herein. Those skilled in the art will readily recognize that the present disclosure is applicable in other environments. In practice, there exist many embodiments and implementations. The appended claims are by no means intended to limit the scope of the present disclosure to the above particular embodiments. Furthermore, any reference to “a device to . . . ” is an explanation of device plus function for describing elements and claims, and it is not desired that any element using no reference to “a device to . . . ” is understood as an element of device plus function, even though the wording of “device” is included in that claim.

Although a particular preferred embodiment or embodiments have been shown and the present disclosure has been described, it is obvious that equivalent modifications and variants are conceivable to those skilled in the art in reading and understanding the description and drawings. Especially for various functions executed by the above elements (portions, assemblies, apparatus, and compositions, etc,), except otherwise specified, it is desirable that the terms (including the reference to “device”) describing these elements correspond to any element executing particular functions of these elements (i.e. functional equivalents), even though the element is different from that executing the function of an exemplary embodiment or embodiments illustrated in the present disclosure with respect to structure. Furthermore, although the a particular feature of the present disclosure is described with respect to only one or more of the illustrated embodiments, such a feature may be combined with one or more other features of other embodiments as desired and in consideration of advantageous aspects of any given or particular application.

1. A method for transmitting packets in virtual network, comprising:
receiving, by an access switch, a Layer 3 packet carrying a virtual network identifier (VNID) from a virtual machine (VM) in a remote data center;
determining, by the access switch, a designated node (DN) corresponding to the VNID;
generating, by the access switch, a Layer 2 frame according to the Layer 3 packet, where, the Layer 2 frame comprises a media access control (MAC) address of the DN; and
transmitting, by the access switch to the DN, the Layer 2 frame according to the MAC address of the DN, such that the DN determines a Layer 3 destination address according to the Layer 2 frame.

2. The method according to claim 1, wherein determining the DN corresponding to the VNID comprises:
looking up, by the access switch, a VN-DN MAC table according to the VNID, and determining the DN corresponding to the VNID;
wherein the VN-DN MAC table indicates a mapping between designated node MAC address and VNID.

3. A method for transmitting packets in virtual network, comprising:
receiving, by a top of rack (TOR) switch, a Layer 2 frame carrying a virtual network identifier (VNID);
extracting, by the TOR switch, a Layer 3 destination address from the Layer 2 frame;
determining, by the TOR switch, whether a Virtual Machine (VM) corresponding to the Layer 3 destination address is in the TOR switch or the VM has migrated;
determining, by the TOR switch, another TOR switch to which the VM was migrated, according to the VNID and the Layer 3 destination address, when the VM has migrated, and transmitting the Layer 2 frame to the another TOR switch to which the VM migrated.

4. The method according to claim 3, wherein determining another TOR switch comprises:
looking up, by the TOR switch, a Layer 2 table according to the Layer 3 destination address, and determining the another TOR switch to which the VM was migrated;
wherein the Layer 2 table indicates at least one of the following: a mapping between VM IP address and TOR MAC address for migrated VM and a mapping between VM IP address and VM MAC address for non-migrated VM.

5. The method according to claim 3, further comprising:
determining the VM MAC address according to the VNID and the Layer 3 destination address, when the VM is in the TOR switch, and transmitting the Layer 2 frame to the VM.

6. The method according to claim 5, wherein determining the VM MAC address comprises:
looking up, by the TOR switch, the Layer 2 table according to the Layer 3 destination address, and determines the migrated VM;
wherein the Layer 2 table indicates at least one of the following: the Layer 2 table indicates a mapping between VM IP address and TOR MAC address for migrated VM and a mapping between VM IP address and VM MAC address for non-migrated VM.

7. A method for transmitting packets in virtual network, the method comprising:
receiving, by a top of rack (TOR) switch, an address resolutin protocol (ARP) broadcast transmitted by a VM which migrated to the TOR switch;
checking, by the TOR switch, a virtual network identifier (VNID) corresponding to the ARP broadcast;
determining, by the TOR switch, whether the TOR switch is the designated node (DN) corresponding to the VNID;
generating, by the TOR switch, a proxy ARP broadcast with the TOR MAC address, and broadcasting the proxy ARP broadcast along with the VNID, when the TOR switch is not the DN corresponding to the VNID;
updating, by the TOR switch, a Layer 2 table, when the OTR switch is the DN corresponding to the VNID.

8. An access switch, comprising:
a receiving unit configured to receive a Layer 3 packet carrying a virtual network identifier (VNID) from a virtual machine (VM) in a remote data center;
a determining unit configured to determine a Designated Node (DN) corresponding to the VNID;
a generating unit configured to generate a Layer 2 frame according to the Layer 3 packet, where, the Layer 2 frame comprises the media access control (MAC) address of the DN; and
a transmitting unit configured to transmit the Layer 2 frame to the DN according to the MAC address of the DN, such that the DN determines a Layer 3 destination address according to the Layer 2 frame.

9. The access switch according to claim 8, wherein the determining unit is configured to look up a VN-DN MAC table according to the VNID, and determine the DN corresponding to the VNID,
wherein the VN-DN MAC table indicates a mapping between designated node MAC address and VNID.

10. A top of rack (TOR) switch, comprising:
a receiving unit configured to receive a Layer 2 frame carrying a virtual network identifier (VNID);
an extracting unit configured to extracting a Layer 3 destination address from the Layer 2 frame;
a determining unit configured to determine whether a virtual machine (VM) corresponding to the L3 destination is in the TOR switch or has migrated,
a first performing unit configured to determine another TOR switch to which the VM was migrated, according to the VNID and the Layer 3 destination address, and transmit the Layer 2 frame to the another TOR switch where the VM migrated, when the VM has migrated.

11. The TOR switch according to claim 10, wherein the first performing unit is configured to look up a Layer 2 table according to the Layer 3 destination address, and determine the another TOR switch to which the VM was migrated,
wherein the Layer 2 table indicates at least one of the following: a mapping between VM IP address and TOR MAC address for migrated VM and a mapping between VM IP address and VM MAC address for non-migrated VM.

12. The TOR switch according to claim 10, further comprising:
a second performing unit configured to determine the MAC address of the migrated VM, according to the Layer 3 destination address, and transmit the Layer 2 frame to the VM, when the VM is in the TOR switch.

13. The TOR switch according to claim 12, wherein the second performing unit configured to look up a Layer 2 table according to the Layer 3 destination address, and determine the migrated VM,
wherein the Layer 2 table indicates at least one of the following: a mapping between VM IP address and TOR MAC address for migrated VM and a mapping between VM IP address and VM MAC address for non-migrated VM.

14. A top of rack (TOR) switch, comprising:
a receiving unit configured to receive an address resolutin protocol (ARP) transmitted by a virtual machine (VM) which migrated to the TOR switch;
a checking unit configured to determine a virtual network identifier (VNID) corresponding to the ARP;
a determining unit configured to determine whether the TOR switch is the DN corresponding to the VNID or not;
a performing unit configured to generate a proxy ARP broadcast with the TOR MAC address and broadcast the proxy ARP broadcast along with the VNID, if the TOR switch is not the DN corresponding to the VNID, and
a updating unit configured to update the Layer 2 table, if the TOR switch is the DN corresponding to the VNID.

15. A communication system for a virtual network, comprising:
an access switch configured to receive a Layer 3 packet from a remote Data Center carrying a virtual network identifier (VNID), determine a designated node (DN) corresponding to the VNID, generate a Layer 2 frame carrying the VNID according to the Layer 3 packet, and transmit the Layer 2 frame to the DN; and
a TOR switch, configured to receive the Layer 2 frame carrying the VNID, extract a Layer 3 destination address according to the Layer 2 frame, determine another TOR switch or a migrated VM, and transmit the Layer 2 frame to the another TOR switch or the migrated VM.

16. The system according to claim 15, wherein the access switch is configured to look up a VN-DN MAC table according to the VNID, and determine the DN corresponding to the VNID,
wherein the VN-DN MAC table indicates a mapping between designated node MAC and VNID.

17. The system according to claim 15, wherein the TOR switch is further configured to look up a Layer 2 table according to the Layer 3 destination address, and determine the another TOR switch to which the VM migrated,
wherein the Layer 2 table indicates at least one of the following: a mapping between VM IP address and TOR MAC address for migrated VM and a mapping between VM IP address and VM MAC address for non-migrated VM.

18. The system according to claim 17, wherein the TOR switches is further configured to check VNID to which the VM corresponds, generate a proxy ARP broadcast carrying the VNID, if the TOR switch is not the DN corresponding to the VNID; update the Layer 2 table, if the TOR switch is the DN corresponding to the VNID.
